(19) United States
(12) Patent Application Publication
(10) Pub. No.: US 2004/0061928 A1
(43) Pub. Date: Apr. 1, 2004

(54) Artificially structured dielectric material

(76) Inventor: William Stewart, Blakesley (GB)

Correspondence Address: Kirschstein Ottinger, Israel & Schiffmiller, 489 Fifth Avenue, New York, NY, 10017-6105, US

(21) Appl. No.: 10/381,171

(22) PCT Filed: Sep. 25, 2001
(86) PCT No.: PCT/GB01/04273

(30) Foreign Application Priority Data
Sep. 25, 2000 (GB) 0023478.1
Nov. 2, 2000 (GB) 0026841.7

(51) Int. Cl. G02F 1/00

(52) U.S. Cl. 359/321

(57) ABSTRACT

An artificially structured dielectric material having optical properties which depend upon the intensity of light incident on the material is described. The material (2) comprises: an array of resiliently moveable mechanical elements (6) of a dielectric material which are attached to a substrate (4). The elements (6) are configured such that when the material is illuminated with light (8) of a selected intensity and wavelength the elements (6) move towards the region of higher intensity of the light thereby altering the optical properties of the material (2).

This invention relates to an artificially structured dielectric material having optical properties.

An artificially structured dielectric material is a structure whose optical properties result from the structure rather than the intrinsic properties (that is those which arise from the electronic properties) of the material from which the structure is composed. Examples of artificially structured dielectric materials are those which exhibit photonic band gap (PBG) behaviour, that is the material structure inhibits the propagation of light within a certain range of wavelengths. Such behaviour, which is an optical analogue of an electronic band gap in a semiconductor, arises from the material having been artificially structured to include a periodic variation in the dielectric constant. Such materials have attracted considerable interest as some believe that such materials could provide the key to fully integrated optical circuits. One example of a PBG structure comprises a substrate having a regular array of holes etched into its surface with a spacing corresponding to a quarter of the wavelength of the light such to introduce a periodic variation in the dielectric constant as experienced by light propagating in the direction of the variation.

In optical telecommunications it is desirable, to increase transmission data rates, to be able to process data within the network in the optical domain, using for example optically controlled switches or gates, without the need for conversion back to an electrical signal. Such systems are termed photonic networks.

To optically process data requires elements which exhibit non-linear optical effects, that is their optical properties, namely refractive index, is at any instant of time dependent on the intensity or other characteristics of the illumination. One example of a non-linear optical processor is a non-linear optical loop mirror (NOLM) which is based on an optical fibre interferometer using the Sagnac configuration and in which the non-linear element comprises a loop of optical fibre. In a NOLM an input coupler splits input light pulses into two counter propagating pulses, which are subsequently recombined at the coupler to form the output, each having travelled around the optical fibre loop. To unbalance the symmetry of the interferometer a high intensity optical control pulse is additionally input into the fibre loop to travels in one direction around the loop. The control pulse has the effect of inducing a refractive index change in the fibre which is experienced by the co-propagating light pulse and to a lesser extent by the counter-propagating light pulse such that there is a net phase shift between the two pulses when they are recombined. Since the switching mechanism results from an intrinsic property of the optical fibre material, ultra fast switching is theoretically possible since the response and reaction times for the non-linear effect are estimated to be of a few femto seconds.

A particular limitation of this type of arrangement is the very small optical non-linearity of glass, which for silica is of the order of 3×10⁻² m² W⁻¹, which requires an optical power length product of 1 Wkm for the optical control signal. For a practical device this would require an optical loop of several kilometres in order to keep the average power of the optical control signal to a practical level (<100 mW).

The present invention has arisen in an endeavour to provide an artificially structured material having non-linear optical properties and which can be integrated with an optical device.

According to the present invention an artificially structured dielectric material comprises: an array of resiliently moveable mechanical elements attached to a substrate, said elements being configured such that when the material is illuminated with light of a selected intensity and wavelength the elements move towards the region of higher intensity of the light thereby altering the optical properties of the material.

The elements can themselves be resiliently flexible and/or resiliently flexibly attached to the substrate.

The array of elements can comprise an irregular or regular array. In either case it is preferred that the average periodicity of the array is significantly smaller than the selected wavelength such, the light interacts with the structured material as though it were a continuous medium. For example the average periodicity of the array is selected to be typically less than a quarter of the selected wavelength.

When the elements are configured as a regular array it can further be preferred that the period of the array is of order of a quarter of the selected wavelength such that the structure comprises a photonic crystal. Such an arrangement will result in the changes in optical properties being enhanced for a given mechanical movement/deformation of the elements and can also give more control over the nature of such changes. For example the effective index change could arranged to be negative.

Advantageously the elements and substrate comprise a semiconductor material such as silicon, gallium arsenide, indium phosphide or other III-V semiconductor materials. Preferably the elements are formed integrally as part of the substrate and are advantageously arranged like the tines of a brush or fork.

In one arrangement, in which the array is irregular, the elements and substrate advantageously comprise porous silicon.

According to a further aspect of the invention a non-linear optical component whose refractive index can be altered by illuminating it with light of a selected intensity and wavelength incorporates an artificially structured material as described above.

In order that the invention can be better understood an artificially structured material in accordance with the invention will now be described by way of reference to the accompanying drawings in which:

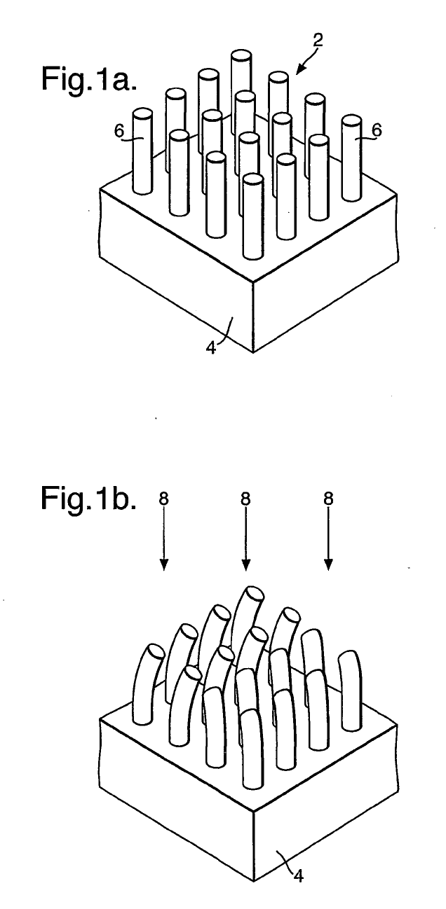

FIG. 1(a) is a schematic representation of an artificially structured material in accordance with the invention;

FIG. 1(b) is the structured material of FIG. 1(a) when it is illuminated with light;

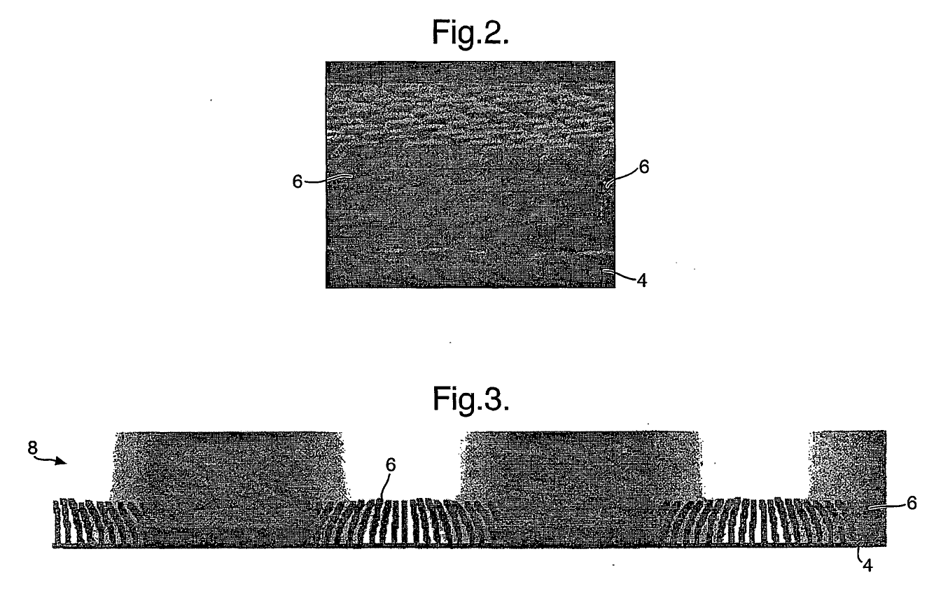

FIG. 2 is an electron micro-graph of an artificially structured material in accordance with the invention;

FIG. 3 is a schematic representation of an artificially structured material in accordance with the invention when it is illuminated with light in a transverse direction; and

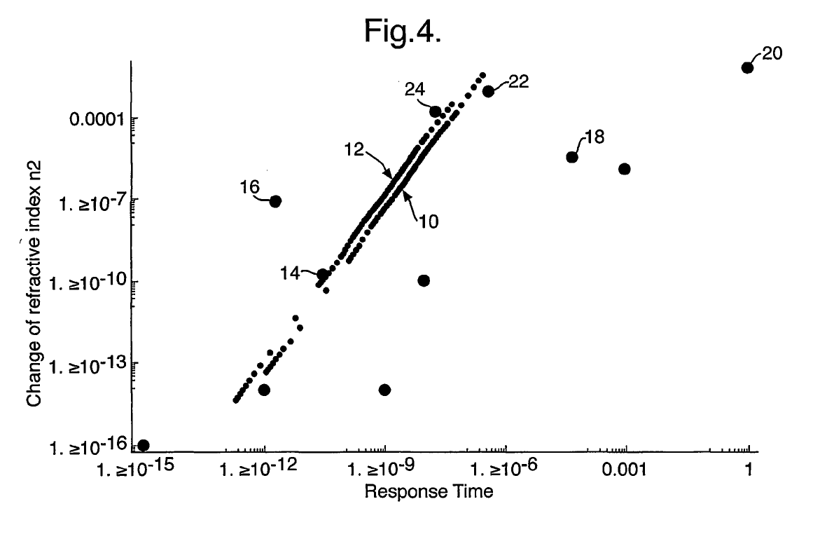

FIG. 4 is a plot of calculated non-linear refractive index (n2) versus response time for artificially structured materials in accordance with the invention.

Referring to FIG. 1(a) there is shown a schematic representation of an artificially structured dielectric material 2 in accordance with the invention. The material 2 comprises a substrate 4 of gallium arsenide which has been selectively etched to form an array of pillars or tines 6 on an upper surface (as illustrated) of the substrate 4. In the embodiment illustrated the pillars 6, hereinafter referred to as elements, are substantially circular in cross-section and are hexagonally close packed. It will be appreciated that elements of other geometries can be used which are arranged on other regular arrays and even irregular. (random) arrays.

An important aspect of the material is the geometry of the elements 6 which is configured such that they are resiliently moveable/deformable when the material is illuminated with light of a selected wavelength and intensity. This is best illustrated with reference to FIG. 1(b) which shows the effect upon the elements 6 when the material is illuminated with a light spot 8. As can be seen from the Figure the elements 6 which are of dimensions such that they can be resiliently deformed, bent, by the illuminating light 8. The pillars 6, which due to them being composed of a dielectric material, are bent towards the higher field region of light under the influence of the optical field thereby altering the average density of elements 6 in this region. As a result of this increase in average density the average refractive index in the region is increased and other optical properties such as the surface reflectivity are altered. It will be appreciated therefore that the optical properties of the structured material depend upon the intensity gradient of light illuminating the structured material. It should be noted that deformation of the elements in this manner is not in consequence of the light exerting an optical pressure (direct optical pressure is a much smaller effect) and also occurs when the material is illuminated by light in a transverse direction as illustrated in FIG. 3. Furthermore since this effect is dependent on the intensity gradient of the light, rather than intensity, it will consequently be greatest nearer to the periphery of the light spot as this will generally have a Gaussian intensity profile. Thus it will be appreciated that if the entire surface of the material were to be illuminated with light of uniform intensity the effect will not occur.

Referring to FIG. 2 there is shown an electron micro-graph of an artificially structured material in accordance with the invention which is intended for operation with light of a wavelength λ=1550 nm. The material comprises a two dimensional array of gallium arsenide circular pillars of diameter 190 nm and length which are arranged in a hexagonal close packed configuration in which the nearest neighbour spacing is 350 nm. It will be appreciated that since the pillars are arranged as a regular array with a period which is of the order of a quarter of a wavelength of light (λ/4=387.5 nm) the structured material of FIG. 2 is a photonic crystal and will additionally exhibit photonic band gap behaviour.

Referring to FIG. 4 this shows a plot of the calculated non-linear refractive index n2 (change of refractive index) versus the mechanical response time of the element for a series of structured materials in accordance with the invention. The plot illustrates structured materials which are fabricated in gallium arsenide 10 and silicon 12. For reference purposes, the plot additionally includes points 14-24 for known materials whose optical properties arise from the intrinsic properties of the material. These data are from Boyd R W (1992) “Non-Linear Optics” ISBN 0-12121680-2 and are as follows: point 14 is for cadmium selenide doped glass, 16 polydiacetylene, 18 thermal component for liquid crystal, 20 molecular component for liquid crystal, 22 indium antimonide and 24 for a gallium arsenide/gallium aluminium arsenide quantum well.

A particular advantage of the structured material of the present invention is that since the non-linear properties arise from the structure rather than the intrinsic properties of the material, the trade off between the magnitude n2 of the nonlinear optical effect n2 versus the response time of the material can tailored for a given application by appropriate selection of the geometry and or dimensions of the moveable/deformable elements. It will be appreciated that the response time of the elements additionally depends upon mechanical springiness of the elements which itself depends upon the material from which the structure is formed.

The present invention is not limited to the specific embodiment shown and it will be appreciated that variations can be made which are within the scope of the invention. For example whilst the pillars or elements have been described as resiliently deformable, comparatively more rigid elements could be used which are resiliently deformably attached to the substrate or a combination of both. As described the array of elements need not be regular and in one embodiment it is envisaged to use porous silicon. In either case it is preferred that the average periodicity of the array is significantly smaller than the selected wavelength such the light interacts with the structured material as though it were a continuous medium. For example the average periodicity of the array is selected to be typically less than a quarter of the selected wavelength. It will be appreciated that there will be a trade off between making the periodicity sufficiently small compared to the wavelength such that the material behaves as though it were a continuous medium and the size of the non-linear effect which is dependent on the intensity gradient of the illuminating radiation which, for a given spot size, will decrease as the average periodicity decreases. In the present patent application the terms optical and light are to be construed broadly to include not only wavelengths in the visible part of the spectrum but also wavelengths in the infrared and ultraviolet region.

One example of an application of the structured material of the present invention is as part of an optical power limiter. It is envisaged that the power limiter comprises a Fabry-Perot cavity consisting of two planar partially reflecting mirrors having the structured material disposed therebetween. The cavity is dimensioned to be on resonance at an intended operating wavelength. For relatively low optical intensities (power), when the cavity is tuned to the resonant frequency, the limiter will transmit the light substantially unattenuated. As the optical power is increased this will induce a rise in refractive index of the structured material which will progressively de-tune the resonator, thereby limiting the optical power coupled into the cavity and thus transmitted by it. An optical power limiter of this form is considered inventive in its own right.

It will be appreciated that the present will find many applications in which it s required to have a material having non-linear optical properties that can be readily tailored for the application. In many applications it will be preferred that the optical propagation take place along the substrate plane as this will enhance any non-linear effect since light has to propagate through more of the structure.

1. An artificially structured dielectric material comprising: an array of resiliently moveable mechanical elements attached to a substrate, said elements being configured such that when the material is illuminated with light of a selected intensity and wavelength the elements move towards the region of higher intensity of the light thereby altering the optical properties of the material.

2. A material according to claim 1 in which the elements are resiliently flexible.

3. A material according to claim 1 or claim 2 in which the elements are resiliently flexibly attached to the substrate.

4. A material according to any preceding claim in which the elements comprise a regular array.

5. A material according to claim 4 in which the period of the array is of order of a quarter of the wavelength of the light such that the structure comprises a photonic crystal.

6. A material according to any preceding claim in which the elements and substrate comprises a semiconductor material which is selected as being silicon, gallium arsenide, indium phosphide or a III-V semiconductor material.

7. A material according to any preceding claim in which the elements comprise tines integrally formed as part of the substrate.

8. A material according to any one of claims 1 to 6 in which the elements and substrate comprise porous silicon.

9. A non-linear optical component whose refractive index can be altered by illuminating it with light of a selected intensity incorporating an artificially structured material according to any preceding claim.

10. An artificially structured dielectric material having optical properties which depend upon light incident of the material substantially as hereinbefore described with reference to or substantially as illustrated in the accompanying drawings.
